(19) United States
(12) Patent Application Publication
(10) Pub. No.: US 2018/0132107 A1
(43) Pub. Date: May 10, 2018

(54) METHOD AND ASSOCIATED PROCESSOR FOR IMPROVING USER VERIFICATION

(71) Applicant: MEDIATEK INC., Hsin-Chu (TW)

(72) Inventor: Sheng-Hung Lai, New Taipei City (TW)

(21) Appl. No.: 15/715,206

(22) Filed: Sep. 26, 2017

Related U.S. Application Data
(60) Provisional application No. 62/418,301, filed on Nov. 7, 2016.

(51) Int. Cl. H04W 12/10; H04L 29/06

(52) U.S. Cl. CPC H04W 12/10; H04L 63/101

(57) ABSTRACT

The invention provides method and associated processor for improving user verification of a mobile device, comprising: by a processor of the mobile device, obtaining a user-inputted verification signal which results from one or more user-input modules, obtaining one or more user statuses which result from one or more sensor modules, and jointly according to the user-inputted verification signal and the one or more user statuses, determining if the user verification is valid to enable a function of the mobile device.

This application claims the benefit of U.S. provisional application Ser. No. 62/418,301, filed Nov. 7, 2016, the disclosure of which is incorporated by reference herein in its entirety.

### FIELD OF THE INVENTION

The present invention relates to method and associated processor for improving user verification, and more particularly, to method and associated processor determining if user verification is valid jointly according to a user-inputted verification signal and one or more user statuses.

### BACKGROUND OF THE INVENTION

Mobile device, such as smart phone, has become an essential portion of modern life, and is broadly utilized to perform functions involving personalization, privacy and/or secrecy, including: accessing, viewing, sending, receiving and/or managing private data (e.g., notes, files, photos, videos, contents, texts, contact list, address book, daily schedule and/or calendar), banking, bidding, shopping, financing, payment, business transaction, positioning, locating, navigation and/or telecommunication, etc. It is therefore important for a mobile device to verify (identify) whether a current user is an original owner, legitimate possessor, authorized holder, registered member and/or granted guest of a function of the mobile device before enabling the function, especially if the function involves personalization, privacy and/or secrecy.

A prior art of user verification determines whether a mobile device should unlock screen to a current user according to biometric characteristics of the user, such as fingerprint. However, such prior art can be easily compromised. For example, a third party may manipulate finger of original owner to pass the fingerprint verification when the original owner is sleeping or unconscious, or force the original owner to input fingerprint against willingness of the original owner.

### SUMMARY OF THE INVENTION

It is therefore understood that relying on biometric characteristics alone for user verification is unsecure and unsatisfactory. An objective of the invention is providing a method (e.g., 10 in FIG. 1a or 100 in FIG. 1b) for improving user verification of a mobile device (e.g., 210 in FIG. 2). The method may comprise: by a processor (e.g., 204) of the mobile device, obtaining a user-inputted verification signal (e.g., 12 in FIG. 1a or 102 in FIG. 1b) which results from one or more user-input modules (e.g., 206 in FIG. 2); obtaining (e.g., 12 or 102 in FIG. 1a or 1b) one or more user statuses (e.g., s[1] to s[N] in FIG. 2) which result from one or more sensor modules (e.g., 208 in FIG. 2); and jointly according to the user-inputted verification signal and the one or more user statuses, determining if the user verification is valid to enable a function of the mobile device (e.g., 13 in FIG. 1a), e.g., to unlock the mobile device and/or to gain access to an application (app), a database, a website, a contact list, etc.

In an embodiment (e.g., FIG. 1b), the procedure of determining if the user verification is valid jointly according to the user-inputted verification signal and the one or more user statuses may comprise: if the user-inputted verification signal matches an expected verification signal (e.g., 103 or 107 in FIG. 1b), and the one or more user statuses reflect a consistence with a whitelist response (e.g., 104 or 106), then determining that the user verification is valid (e.g., 105).

In an embodiment (e.g., FIG. 1b), the procedure of determining if the user verification is valid jointly according to the user-inputted verification signal and the one or more user statuses may comprise: if the user-inputted verification signal matches an expected verification signal (e.g., 103) but the one or more user statuses reflect an inconsistence with a whitelist response, (e.g., 104), then (e.g., 109) determining that the user verification is invalid, or prompting user to utilize a second verification approach different from a first verification approach that results in the user-inputted verification signal, and accordingly obtaining a second user-inputted verification signal resulting from the second verification approach; if the second user-inputted verification signal matches a second expected verification signal (e.g., 110), determining that the user verification is valid (e.g., 105), and updating the whitelist response (e.g., 111), such that the one or more user statuses reflect a consistence with the updated whitelist response.

In an embodiment, the method may comprise: if the one or more user statuses reflect an inconsistence with a whitelist response, but the user-inputted verification signal matches an expected verification signal, determining that the user verification is valid, and updating the whitelist response, such that the one or more user statuses reflect a consistence with the updated whitelist response.

In an embodiment (e.g., FIG. 1b and FIGS. 5, 6 and 7a-7e), the one or more user statuses may include an activity status (e.g., SA in FIG. 7b-7d) and one or more indication statuses (e.g., si[1] and si[2] in FIGS. 7a-7e); and the activity status may reflect sensed user activity by one of a plurality of predetermined activity types. The procedure of determining if the user verification is valid jointly according to the user-inputted verification signal and the one or more user statuses may further comprise: if each said indication status falls in an associated whitelist range (e.g., 501 in FIG. 5), determining that the one or more user statuses reflect a consistence with the whitelist response (e.g., 502); otherwise, if any said indication status does not fall in said associated whitelist range, checking if the activity status matches any recorded whitelist activity (e.g., 503); if the activity status does not match any recorded whitelist activity, determining that the one or more user statuses reflect an inconsistence with the whitelist response (e.g., 505), and prompting user to utilize a second verification approach different from a first verification approach which results in the user-inputted verification signal, and accordingly obtaining a second user-inputted verification signal resulting from the second approach (e.g., 109 in FIG. 1b); if the second user-inputted verification signal matches a second expected verification signal (e.g., 110), determining that the user verification is valid, and recording the activity status as a whitelist activity (e.g., 601 in FIG. 6); on the other hand, if any said indication status does not fall in said associated whitelist range but the activity status matches a recorded whitelist activity (e.g., 503 in FIG. 5), determining that the one or more user statuses reflect a consistence with the whitelist response (e.g., 502), and accumulating a count associated with the matched recorded whitelist activity; and, if the count associated with the matched recorded whitelist activity reaches a threshold, updating one or more of said one or more whitelist ranges respectively associated with the one or more indication statuses (e.g., 504), such that the one or more indication statuses respectively fall in the associated one or more updated associated whitelist ranges

In an embodiment, the procedure of determining if the user verification is valid jointly according to the user-inputted verification signal and the one or more user statuses may comprise: if the user-inputted verification signal matches the expected verification signal and the one or more user statuses reflect a consistence with a blacklist response, then determining that the user verification is invalid, or prompting user to utilize a second verification approach different from a first verification approach which results in the user-inputted verification signal, and according obtaining a second user-inputted verification signal; if the second user-inputted verification signal matches a second expected verification signal, determining that the user verification is valid, and updating the blacklist response, such that the one or more user statuses reflect an inconsistence with the updated blacklist response.

In an embodiment (e.g., FIG. 4a or 4b), the one or more of user statuses (e.g., s[1] to s[N] in FIG. 2) may include an activity status (e.g., SA in FIG. 4a or 4b) and one or more indication statuses (e.g., si[1]-si[2]); the activity status may reflect sensed user activity by one of a plurality of predetermined activity types (e.g., type_a to type_c), the plurality of predetermined activity types may respectively associate with a plurality of whitelist groups (e.g., G_a to G_c), each said whitelist group (e.g., G_a) may comprise one or more whitelist ranges (e.g., w_a[1] and w_a[2]), each said whitelist range (e.g., w_a[1]) may associates with one (e.g., si[1]) of the one or more indication statuses, and the procedure of determining if the user verification is valid jointly according to the user-inputted verification signal and the one or more user statuses may further comprise: selecting one of said whitelist groups according to the activity status, such that the predetermined activity type associating with the selected whitelist group matches the activity status, and determining that the one or more user statuses reflect a consistence with the whitelist response (e.g., 104 or 106) if each said whitelist range in the selected whitelist group covers the associated indication status. In an embodiment, the one or more indication statuses (e.g., si[1]-si[2]) may reflect at least one of following user physiology information: blood pressure, heartbeat rate, body temperature, respiration rate, voice stress, perspiration, pupil dilation, pupil size, brainwave and tension. In an embodiment, the user-inputted verification signal may reflect at least one of following: biometric characteristics of user, a sequence of positions inputted by user, a trajectory drawn by user, and a string inputted by user.

An objective of the invention is providing a processor (e.g., 204 in

FIG. 2) of a mobile device (e.g., 210). The processor 204 may comprise a core unit (e.g., 200) and an interface circuit (e.g., 202) bridging between the core unit, one or more user-input modules (e.g., 206) and one or more sensor modules (e.g., 208). The core unit may be arranged to improve user verification by: obtaining a user-inputted verification signal (e.g., p1) which results from the one or more user-input modules, obtaining one or more user statuses (e.g., s[1] to s[N]) which result from the one or more sensor modules, and jointly according to the user-inputted verification signal and the one or more user statuses, determining if the user verification is valid to enable a function of the mobile device.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIGS. 1a and 1b illustrate flowcharts according to embodiments of the invention;

FIG. 2 illustrates a mobile device according to an embodiment of the invention;

FIG. 3a, FIG. 3b, FIG. 4a and FIG. 4b illustrate, according to embodiments of the invention, examples of whitelist response shown in FIG. 1b;

FIG. 5 and FIG. 6 illustrate flowcharts according to embodiments of the invention, for steps of the flowchart in FIG. 1b; and

FIGS. 7a to 7e illustrate scenarios of an example of executing the flowchart in FIG. 1b by the flowcharts in FIGS. 5 and 6.

### DETAILED DESCRIPTION OF PREFERRED EMBODIMENTS

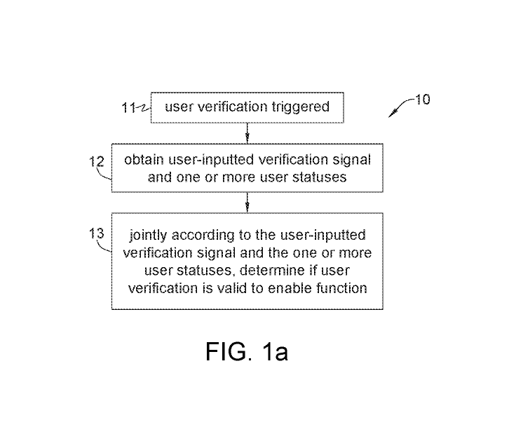

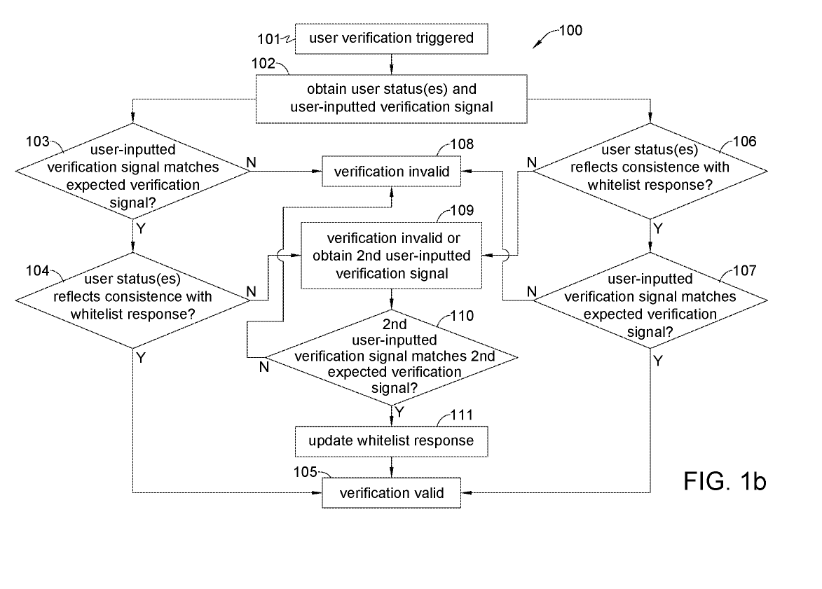

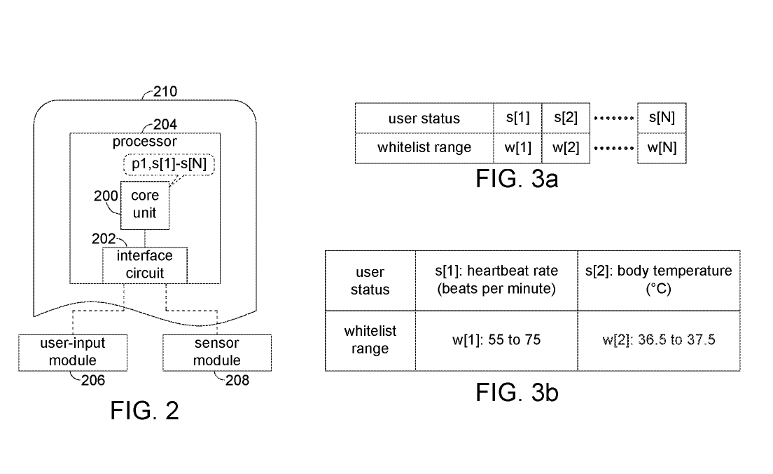

Please refer to FIGS. 1a, 1b and 2. FIG. 1a illustrates a flowchart 10 according to an embodiment of the invention, FIG. 1b illustrates a flowchart 100 according to an embodiment of the invention, and FIG. 2 illustrates a mobile device 210 according to an embodiment of the invention. The mobile device 210 may execute the flowchart 10 or 100 to improve user verification. The examples of the mobile device 210 may include, but not be limited to, a smart phone, a mobile phone, a wearable device, a portable computer, a handheld computer, a tablet computer, a notebook computer, a digital camera, a digital camcorder, a portable game console and/or a navigator. As shown in FIG. 2, the mobile device 210 may include a processor 204, which may include a core unit 200 and an interface circuit 202 bridging between the core unit 200, one or more user-input modules such as 206, and one or more sensor modules such as 208. In different embodiments, one or more of the user-input module 206 and the sensor module 208 may be or may not be part of the mobile device 210. The core unit 200 may be a logic circuit for executing software/firmware codes and accordingly controlling one or more functions of the mobile device 210. The interface circuit 202 may relay signaling between the user-input module 206 and the core unit 200, also relay signaling between the sensor module 208 and the core unit 200.

When a user wants to enable a desired function of the mobile device 210, such as unlocking the mobile device 210 or gaining access to an application (app), a database, a website, a contact list etc., of the mobile device 210, the user-input module 206 may receive verification characteristics inputted by the user, and accordingly inform the core unit 200 via the interface circuit 202. For example, the user-input module 206 may include a camera, touch pad, touch panel or touch screen (not shown) for capturing biometric characteristics (e.g., iris, fingerprint, etc.) inputted by the user; and/or, the user-input module 206 may include a camera, touch pad, touch panel or touch screen (not shown) for detecting a sequence of positions inputted by the user, a trajectory drawn by the user, and/or a sequence of numbers, characters and/or letters inputted by the user.

On the other hand, when the user wants to enable the desired function of the mobile device 210, the sensor module 208 may sense surroundings accompanying the characteristics inputted to the user-input module 206, so as to reflect one or more additional aspects of the user (i.e., one or more aspects other than the inputted characteristics), such as current activity (e.g., sleeping, sitting, walking, working, jogging, exercising or driving), location, position, posture, velocity, acceleration, gravity direction, geometric magnetic field, and/or physiology signs of the user, e.g., blood pressure, heartbeat rate, body temperature, respiration rate, voice stress, perspiration, pupil dilation, pupil size, brainwave and tension.

In one embodiment, to sense the additional aspect(s) of the user, the sensor module 208 may include one or more sensors (not shown) on the mobile device 210, and/or one or more sensors on peripheral(s) (not shown) of the mobile device 210; the peripheral(s) may not need to be directly attached to the mobile device 210, but be remotely communicable with the mobile device 210. For example, the peripheral(s) may include camcorder, camera, wrest watch, armlet, glasses, earphone, headset, and/or clothes (hat and/or shirt, etc.) woven with embedded sensor(s). None, one or more sensors of the sensor module 208 may be integrated with the user-input module 206; for example, the mobile device 210 may include a touch pad to receive user inputted characteristics for the user-input module 206, and to detect stress, blood pressure and/or heartbeat rate for the sensor module 208.

As shown in FIG. 1a, main steps of the flowchart 10 may be described as follows.

Step 11: when a user wants to enable a desired function of the mobile device 210 and therefore interacts with the user-input module 206 and/or the sensor module 208, the flowchart 10 for user verification may be triggered to start, and proceed to step 12.

Step 12: the sensor module 208 may sense the additional aspects of the user, the user-input module 206 may receive characteristics inputted by the user, and the core unit 200 may therefore obtain a user-inputted verification signal p1 (FIG. 2) which results from the inputted characteristics received by the user-input module 206, and obtain one or more user statuses s[1] to s[N] which results from the additional aspect(s) sensed by the sensor module 208.

Step 13: the core unit 200 may determine if user verification is valid to enable a desired function of the mobile device 210 jointly according to the user-inputted verification signal and the one or more user statuses.

The flowchart 10 in FIG. 1a may be further detailed by the flowchart 100 in FIG. 1b. As shown in FIG. 1b, major steps of the flowchart 100 may be described as follows.

Step 101: when a user wants to enable a desired function of the mobile device 210 and therefore interacts with the user-input module 206, the flowchart 100 for user verification may be triggered to start, and proceed to step 102.

Step 102: the sensor module 208 may sense the additional aspects of the user, the user-input module 206 may receive characteristics inputted by the user, and the core unit 200 may therefore obtain a user-inputted verification signal p1 (FIG. 2) which results from the inputted characteristics received by the user-input module 206, and obtain a number N (one or more) of user statuses s[1] to s[N] which results from the additional aspect(s) sensed by the sensor module 208. In an embodiment, the flowchart 100 may branch to step 103 or 106 according to whether the user inputted verification signal p1 is considered before the user statuses s[1] to s[N]. If the signal p1 is considered first, the flowchart 100 may proceed to step 103; otherwise, if the user statuses s[1] to s[N] are considered first, the flowchart 100 may proceed to step 106. Then, as described in following steps, the core unit 200 may determine if the user verification is valid to enable the desired function of the mobile device 210 jointly according to the user-inputted verification signal p1 and the user statuses s[1] to s[N]. Please note that in some embodiments, step 102 may be separated into two steps such as obtaining user status(es) and obtaining user-inputted verification signal; and obtaining user status(es) may be performed anytime before determining if user status(es) reflects consistence with whitelist response (e.g., anytime before step 104 or step 106), and obtaining user-inputted verification signal may be performed anytime before determining if user-inputted verification signal matches expected verification signal (e.g., anytime before step 103 or step 107).

In an embodiment, the user-input module 206 may send the received characteristics to the processor 204, so the core unit 200 may identify features of the received characteristics to form the signal p1. In an embodiment, the user-input module 206 itself may include a microprocessor to identify features of the received characteristics to form the signal p1, and then send the signal p1 to the core unit 200. Similarly, in an embodiment, the sensor module 208 may send the sensed additional aspect(s) to the processor 204, so the core unit 200 may extract features of the additional aspect(s) to form the user statuses s[1] to s[N]. In an embodiment, the sensor module 208 itself may include a microprocessor to extract features of the sensed additional aspect(s) to form the user statuses s[1] to s[N], and then send the user statuses s[1] to s[N] to the core unit 200. In an embodiment, the sensor module 208 may send a first subset of the sensed additional aspects to the processor 204, so the core unit 200 may extract features of the first subset of the additional aspects to form a second subset of the user statuses s[1] to s[N]; furthermore, the sensor module 208 itself may include a microprocessor to extract features of a third subset of the sensed additional aspects to form a fourth subset of the user statuses s[1] to s[N], and then send the fourth subset of the user statuses s[1] to s[N] to the core unit 200, so the core unit 200 may obtain the user statuses s[1] to s[N] by a union of the second subset and the fourth subset. Each user status may be derived (by the core unit 200 and/or microprocessor of the sensor module 208) from one or more sensed additional aspects. For example, a user status capable of reflecting current activity of the user by sitting, walking, jogging, working exercising or driving may be derived from sensed velocity, acceleration, position, heartbeat rate and/or respiration.

Step 103: the core unit 200 may check whether the user-inputted verification signal p1 matches an expected verification signal. If the user-inputted verification signal p1 matches the expected verification signal, the core unit 200 may proceed to step 104. Otherwise, if the user-inputted verification signal p1 does not match the expected verification signal, the core unit 200 may proceed to step 108. The expected verification signal may be built in advance by the original owner of the mobile device 210.

Step 104: the core unit 200 may check whether the user statuses s[1] to s[N] reflect a consistence with a whitelist response. If the user statuses s[1] to s[N] reflect a consistence with the whitelist response, then the core unit 200 may proceed to step 105. On the other hand, if the user statuses s[1] to s[N] fail to reflect a consistence with the whitelist response, then the core unit 200 may proceed to step 109.

Step 105: the core unit 200 may determine that the user verification is valid, and then execute the desired function of the mobile device 210. It is therefore noted that, according to the invention, enabling the desired function may require multi-level confirmation jointly according to not only the user-inputted verification signal p1 (step 103) which may result from the characteristics received by the user-input module 206, but also the user statuses s[1] to s[N] (step 104) which may result from the additional aspect(s) sensed by the sensor module 208. Hence security of user verification is improved. For example, in an embodiment, the user statuses s[1] to s[N] may collectively reflect whether the user is asleep (unconscious) or feels nervous, and the whitelist response (step 104) may be associated with a condition that the user is awake (conscious) and calm (not too nervous, not too relaxed), hence the user statuses s[1] to s[N] reflect a consistence with the whitelist response when the user is awake and calm. Accordingly, rather than merely inputting correct verification characteristics (e.g., fingerprint), enabling the desired function of the mobile device 204 according to the invention requires the user to input correct verification characteristics in a conscious and calm manner, and hence avoids to be compromised by unconsciousness and/or unwillingness of the original owner.

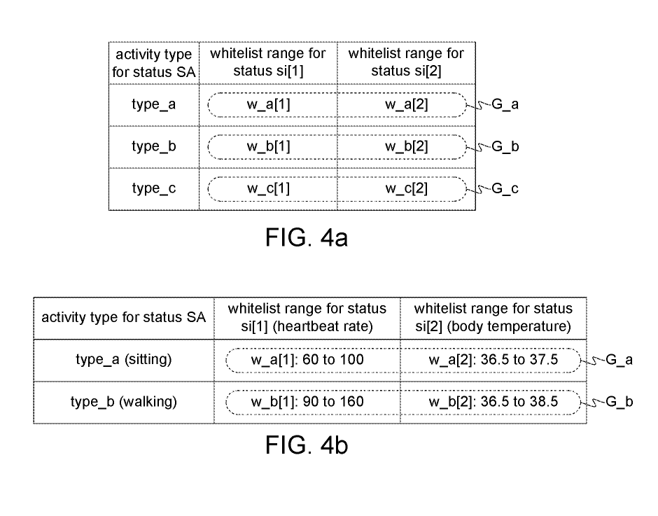

Along with FIG. 1b and FIG. 2, please refer to FIG. 3a illustrating an example according to an embodiment of step 104. To determine whether the user statuses s[1] to s[N] reflect a consistence with the whitelist response in step 104, the core unit 200 may access a number N of whitelist ranges w[1] to w[N] (e.g., from a database in the mobile device 210, not shown) respectively associated with the user statuses s[1] to s[N], and compare whether each user status s[n] is in the associated whitelist range w[n], for n=1 to N. If all the statuses s[1] to s[N] are respectively covered by the associated whitelist ranges w[1] to w[N], the core unit 200 may determine that the user statuses s[1] to s[N] reflect a consistence with a whitelist response. The whitelist response can be collectively formed by the whitelist ranges w[1] to w[N]. If one or more of the user statuses s[1] to s[N] is not covered by the associated whitelist range(s), the core unit 200 may determine that the user statuses s[1] to s[N] fail to reflect a consistence with the whitelist response; in other words, the core unit 200 may determine that the user statuses s[1] to s[N] reflects an inconsistence with the whitelist response. For example, the user status s[1] may rate user consciousness from “0” to “9” for lowest consciousness to highest consciousness, and the associated whitelist range w[1] may be “greater than 6.” In some embodiments, the whitelist range may be a union of non-overlapping subranges, such as a union of “between 2 and 3” and “greater than 8.” As another example, please refer to FIG. 3b illustrating an example according to an embodiment of step 104 which may adopt two user statuses s[1] and s[2] respectively associated with two whitelist ranges w[1] and w[2]. For example, the user status s[1] may reflect sensed heartbeat rate, and the associated whitelist range w[1] may require 55 to 75. The user status s[2] may reflect sensed body temperature, and the associated whitelist range w[2] may require 36.5 to 37.5. In this embodiment, if the user status s[1] (sensed heartbeat rate) is in the whitelist range [1] and the user status s[2] (sensed body temperature) is in the whitelist range w[2], the user statuses s[1] and s[2] may be determined to be consistent with the whitelist response.

Along with FIG. 1b and FIG. 2, please refer to FIG. 4a illustrating an example according to an embodiment of step 104. As shown in FIG. 4a, the number N of user statuses s[1] to s[N] may include an activity status SA and a quantity M (one or more) of indication statuses si[1] to si[M], such as the statuses si[1] and si[2] in the example of FIG. 4a. The activity status SA may reflect sensed user activity by one of a plurality of predetermined activity types, such as sitting, working, walking, jogging, exercising and/or driving; these predetermined activity types may respectively associate with a plurality of whitelist groups. In the example of FIG. 4a, there are three predetermined activity types type_a, type_b and type_c respectively associated with three whitelist groups G_a, G_b and G_c. Each whitelist group may include one or more whitelist ranges, and each whitelist range may associate with one of the indication statuses si[1] to si[M]. In the example of FIG. 4a, the whitelist group G_a includes two whitelist ranges w_a[1] and w_a[2] respectively associated with the indication statuses si[1] and si[2]; similarly, the whitelist group G_b includes two whitelist ranges w_b[1] and w_b[2] respectively associated with the indication statuses si[1] and si[2]. In the example of FIG. 4a, to implement step 104 for determining if the user statuses reflects a consistence with a whitelist response, the core unit 200 may select one of said whitelist groups G_a to G_c according to the activity status SA, such that the predetermined activity type associating with the selected whitelist group matches the activity status SA. For example, if the activity status SA indicates type_b, then the core unit 200 may select the whitelist group G_b, since the predetermined activity type type_b associated with the selected whitelist group G_b matches the activity status SA. Then the core unit 200 may compare if the whitelist ranges w_b[1] and w_b[2] in the selected whitelist group G_b respectively covers the associated indication statuses si[1 ] and si[2]. If each said whitelist range (w_b[1], w_b[2]) in the selected whitelist group G_b covers the associated indication status (si[1], si[2]), the core unit 200 may determine that the user statuses reflect a consistence with the whitelist response.

In other words, the embodiment demonstrated by FIG. 4a may adaptively provide proper whitelist responses (whitelist groups of whitelist ranges to be compared with the indication statuses) for different activity types, since the whitelist response, which is expected to reflect that the user is normal (e.g., calm and conscious), may vary when the user is taking different activities. As another example according to an embodiment of step 104, please refer to FIG. 4b, wherein the activity types type_a and type_b may respectively reflect the user is sitting and walking, the indication status si[1] may indicate heartbeat rate of the user, and the indication status si[2] may indicate heartbeat rate of the user. To reflect that the user is calm and conscious, the whitelist range w_a[1] associated with the “sitting” activity type type_a may be, e.g., “60 to 100,” while the whitelist range w_b[1] associated with the “walking” activity type type_b may be, e.g., “90 to 160,” because the normal heartbeat rate when sitting may be different from the normal heartbeat rate when walking. Similarly, the whitelist range w_a[2] associated with the “sitting” activity type type_a may be, e.g., “36.5 to 37.5,” while the whitelist range w_b[2] associated with the “walking” activity type type_b may be, e.g., “36.5 to 38.5.” Thus, when the activity status SA reflects that the user is sitting (in activity type type_a), consistence with the whitelist response will require the heartbeat rate indication status si[1] to fall in the whitelist range w_a[1] (e.g., “60 to 100”) and the body temperature indication status si[2] to fall in the whitelist range w_a[2] (e.g., “36.5 to 37.5”). On the other hand, when the activity status SA reflects that the user is walking (in activity type type_b), consistence with the whitelist response will require the heartbeat rate indication status si[1] to fall in the whitelist range w_b[1] (e.g., “90 to 160”) and the body temperature indication status si[2] to fall in the whitelist range w_b[2] (e.g., “36.5 to 38.5”).

In an embodiment, the sensor module 208 may include accelerometer (gravity-sensor), gyro sensor and/or rotation sensor, etc., so as to provide the activity status SA as one of the user statuses for indicating activity of the user. In an embodiment, the quantity M of indication statuses si[1] to si[M] may reflect at least one of following user physiology information: blood pressure, heartbeat rate, respiration rate, voice stress, perspiration, pupil dilation, pupil size, brainwave and tension.

Step 106 (FIG. 1b): similar to step 104, the core unit 200 may check whether the user statuses s[1] to s[N] reflect a consistence with a whitelist response. If the user statuses s[1] to s[N] reflect a consistence with the whitelist response, then the core unit 200 may proceed to step 107. On the other hand, if the user statuses s[1] to s[N] fail to reflect a consistence with the whitelist response, then the core unit 200 may proceed to step 109. Similar to step 104, step 106 may be implemented as the examples shown in FIGS. 3a and 3b, wherein the core unit 200 may check whether the user statuses s[1] to s[N] are respectively in the whitelist ranges w[1] to w[N] to determine whether to proceed to step 107 or 109. Or, step 106 may be implemented as the examples shown in FIGS. 4a and 4b, wherein the user statuses s[1] to s[N] may include an activity status SA and indication statuses si[1] to si[M], and the core unit 200 may select one whitelist group according to the activity status SA, and check whether the indication statuses si[1] to si[M] are respectively in the whitelist ranges of the selected whitelist group to determine whether to proceed to step 107 or 109.

Step 107: similar to step 103, the core unit 200 may check whether the user-inputted verification signal p1 matches an expected verification signal. If the user-inputted verification signal p1 matches the expected verification signal, the core unit 200 may proceed to step 105. Otherwise, if the user-inputted verification signal p1 does not match the expected verification signal, the core unit 200 may proceed to step 108.

Step 108: the core unit 200 may determine that the user verification is invalid (failed), refuse to enable the desired function of the mobile device 210, and terminate the flowchart 100. The core unit 200 may also inform the user that the user verification fails by a visual warning message shown on the screen, a warning sound and/or vibration.

Step 109: in an embodiment, the core unit 200 may determine that the user verification is invalid, refuse to enable the desired function, and therefore terminate the flowchart 100. In a different embodiment, the core unit 200 may prompt the user (e.g. by visual cue shown on the screen and/or audio cue via a speaker) to utilize a second verification approach different from a first verification approach that results in the user-inputted verification signal p1 (step 103 or 107), accordingly obtain a second user-inputted verification signal p2 resulting from the second verification approach, and then proceed to step 110.

For example, in an embodiment, the first verification approach in step 102 may be identifying biometric characteristics of the user, such as recognizing fingerprint of the user via a touch pad, capture face image of the user via a camera, etc.; while the second verification approach in step 109 may be detecting a screen pattern (e.g., an orderly sequence of positions touched by user, or a trajectory drawn by user), or receiving a string (password or PIN) inputted by user. In another embodiment, the first verification approach in step 102 may be detecting a screen pattern or receiving a string (password or PIN) inputted by user, while the second verification approach in step 109 may be identifying biometric characteristics of the user.

Step 110: the core unit 200 may check whether the second user-inputted verification signal p2 matches a second expected verification signal. If the second user-inputted verification signal p2 fails to match the second expected verification signal, the core unit 200 may proceed to step 108. On the other hand, in an embodiment, if the second user-inputted verification signal p2 matches the second expected verification signal, the core unit 200 may directly proceed to step 105. In another embodiment, if the second user-inputted verification signal p2 matches the second expected verification signal, the core unit 200 may proceed to step 111.

Step 111: the core unit 200 may update the whitelist response utilized in subsequent execution of step 104 or 106, such that the user statuses s[1] to s[N] may reflect a consistence with the updated whitelist response, and then proceed to step 105. And/or, the core unit 200 may ask the user to manually update the whitelist response. Please note that in some embodiments, step 111 may be omitted (e.g. proceed without updating the whitelist response).

If the flowchart 100 reaches step 111, the user statuses s[1] to s[N] already fail to reflect a consistence with the whitelist response in step 104 or 106, but the second user-inputted verification signals p2 (step 109) matches the second expected verification signals (step 110). Such scenario may imply that the user is actually normal (e.g., calm and conscious), but the whitelist response associated with the normal state in step 104 or 106 is not correctly set. Therefore, the core unit 200 may update (expand or narrow) the whitelist response utilized in step 104 or 106, such that the user statuses s[1] to s[N] may reflect a consistence with the updated whitelist response.

Following the example shown in FIG. 3a, assuming the user status s[1] rates user consciousness to “5” but the associated whitelist range w[1] is “greater than 6,” then step 104 or 106 may branch to steps 109 and 110 to check the second user-inputted verification signal p2. If the second user-inputted verification signal p2 does match the second expected verification signal, the core unit 200 may update the whitelist range w[1] to “not smaller than 5,” and maintain other whitelist ranges w[2] to w[N] unchanged.

Similarly, following the example shown in FIG. 4b, assuming the activity status SA matches the “walking” activity type type_b and the indication status si[1] indicates that the user heartbeat rate is “170” but the associated whitelist range b[1] is “90 to 160,” then step 104 or 106 may branch to steps 109 and 110 to check the second user-inputted verification signal p2. If the second user-inputted verification signal p2 does match the second expected verification signal, the core unit 200 may update the whitelist range w_b[1] to “90 to 175”, while keep other whitelist ranges, e.g., w_b[2] and w_a[1] to w_a[2] unchanged.

In other words, by step 111, the core unit 200 may perform a machine learning (training) for accumulating knowledge to adapt personal differences.

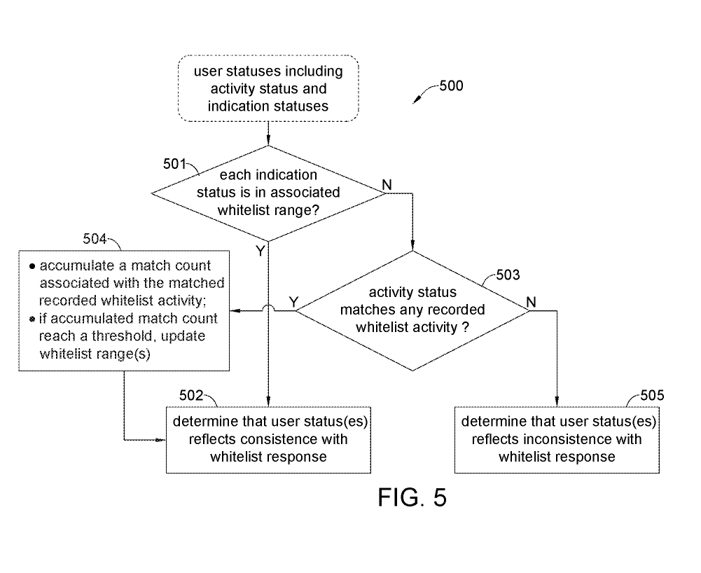

Along with FIG. 1b and FIG. 2, please refer to FIG. 5 illustrating a flowchart 500 according to an embodiment of the invention. In an embodiment, the core unit 200 may execute step 104 or 106 of the flowchart 100 by at least a portion of the flowchart 500 to determine whether the user statuses s[1] to s[N] reflect a consistence with the whitelist response. The flowchart 500 may start with an activity status SA and one or more indication statuses si[1 ] to si[M] included in the user statuses s[1] to s[N]. In some embodiments, the flowchart 500 may start without activity status SA and obtain activity status SA only when necessary. Main steps of the flowchart 500 may be described as follows.

Step 501: the core unit 200 may compare if each indication status si[m] (for m=1 to M) falls in an associated whitelist range w[m]. If all the indication status si[1] to si[M] respectively fall in the associated whitelist ranges w[1] to w[M], the core unit 200 may proceed to step 502, otherwise proceed to step 503.

Step 502: the core unit 200 may determine that the user statuses do reflect consistence with the whitelist response, and exit the flowchart 500.

Step 503: the core unit 200 may further refer to the activity status SA, and check if the activity status SA matches any recorded whitelist activity. If the activity status SA matches a recorded whitelist activity, the core unit 200 may proceed to step 504, otherwise proceed to step 505.

Step 504: the core unit 200 may accumulate (e.g., increment) a match count associated with the matched recorded whitelist activity. If the match count associated with the matched recorded whitelist activity reaches a threshold, the core unit 200 may update one or more of the whitelist ranges w[1] to w[M] respectively associated with the indication statuses si[1] and si[M], such that the indication statuses si[1] to si[M] may respectively fall in the associated updated whitelist ranges w[1] to w[M]. The core unit 200 may proceed to step 502.

Step 505: the core unit 200 may determine that the user statuses do not reflect consistence with the whitelist response, and exit the flowchart 500.

In some embodiments, steps 503 and/or 504 may be performed after step 110 of FIG. 1b. In some embodiments, steps 503 and 504 may be ignored. For example, if it is determined in step 501 that not each indication status is in associated whitelist range, the flowchart 500 may proceed to step 505 directly and the flowchart 100 (FIG. 1b) may proceed to steps 109 and 110. And after steps 109 and 110, the flowchart 100 may proceed to steps 105 or 108 without performing steps 503 and 504, or the flowchart 100 may proceed to step 105 (if answer is YES in step 110) and record the activity status. The recorded activity status may be used when step 503 is performed. For another example, after it is determined in step 501 that not each indication status is in associated whitelist range, the flowchart 500 may proceed to step 503 and then steps 502 or 505 without performing step 504.

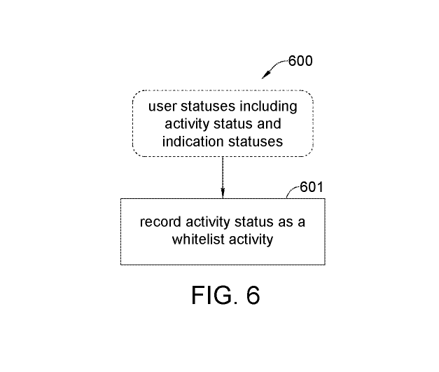

Along with FIGS. 1, 2 and 5, please refer to FIG. 6 illustrating a flowchart 600 according to an embodiment of the invention. In cooperation with the flowchart 500 in FIG. 5, in an embodiment, the core unit 200 may execute step 111 of the flowchart 100 (FIG. 1b) by the flowchart 600 in FIG. 6 and/or step 504 in FIG. 5. The flowchart 600 may start with an activity status SA and one or more indication statuses si[1] to si[M] included in the user statuses s[1] to s[N]. Main steps of the flowchart 600 may be described as follows.

Step 601: the core unit 200 may record the activity status SA as a whitelist activity, and then exit the flowchart 600.

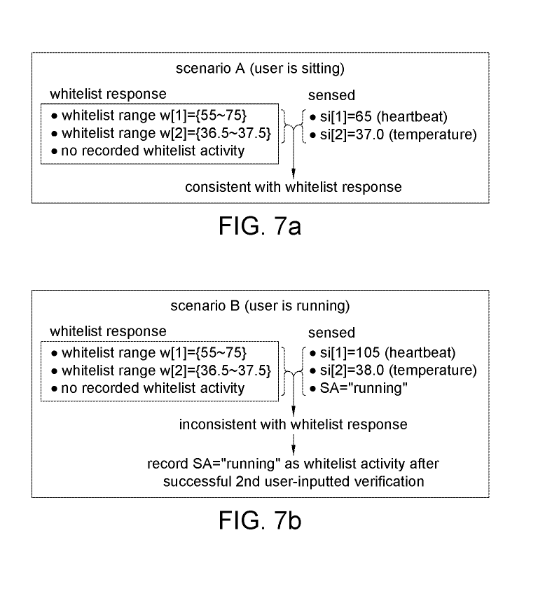

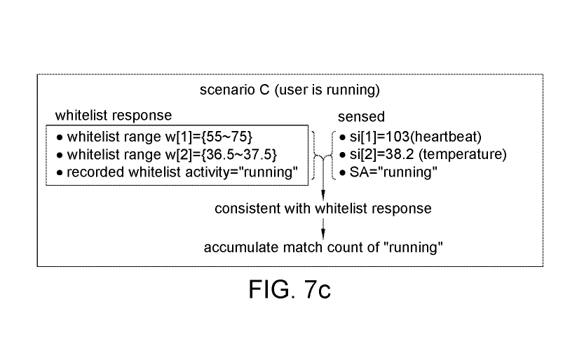

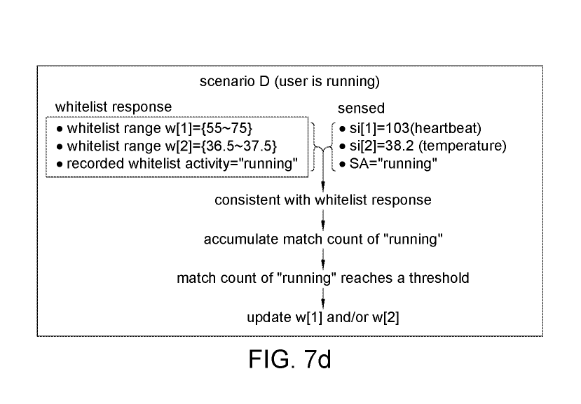

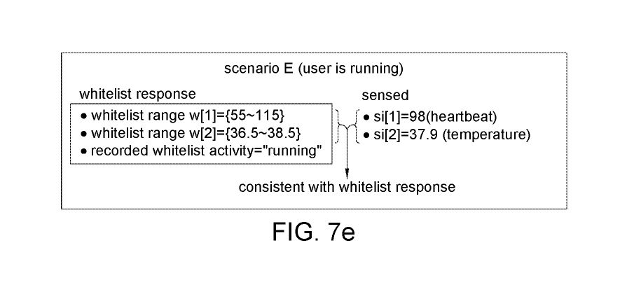

Along with FIGS. 1b, 2, 5 and 6, please refer to FIGS. 7a to 7e illustrating different scenarios of an example executing the flowchart 100 in FIG. 1b, with the flowchart 500 in FIG. 5 adopted for steps 104, 106 and 111 of the flowchart 100, and the flowchart 600 in FIG. 6 adopted for step 111. In a scenario A shown in FIG. 7a, user wants to enable a desired function, so the core unit 200 may execute the flowchart 100, wherein the whitelist response may include multiple whitelist ranges w[1] to w[2], but may not include any recorded whitelist activity. In the scenario A, it is assumed that user is sitting; therefore, when the core unit 200 executes step 104 or 106, the core unit 200 may execute step 501 of the flowchart 500 (FIG. 5) to find that all the sensed indication statuses si[1] to si[2] correctly fall in the whitelist ranges w[1] to w[2], and then proceed to step 502 to determine that the user statuses reflect a consistence with the whitelist response.

In a later scenario B, user again wants to enable a desired function, so the core unit 200 may execute the flowchart 100 again. In the scenario B, it is assumed that user is running. Therefore, when the core unit 200 executes step 104 or 106, the core unit 200 may find that not all the sensed indication statuses si[1] and si[2] fall in the whitelist ranges w[1] and w[2] in step 501 of the flowchart 500, and then proceed to step 503 to consult another sensed activity status SA included in the user statuses besides the indication statuses si[1] and si[2]. Because user is running, the activity status SA may equal “running”. However, since the whitelist response does not include any recorded whitelist activity, the activity status SA fails to match any recorded whitelist activity in step 503, and the core unit 200 may proceed to step 505 to determine that the user statuses reflect an inconsistence with the whitelist response. Then the core unit 200 may proceed to step 109 (FIG. 1) to obtain a second user verification signal. In the scenario B, it is assumed that the second user verification signal successfully matches a second expected verification signal in step 110, so the core unit 200 may execute step 105 to achieve a valid verification, and execute step 111 by step 601 of the flowchart 600 (FIG. 6) to record the current sensed activity SA=“running” as a whitelist activity in the whitelist response. Because of the successful second user inputted verification (steps 109 and 110), the core unit 200 may learn that: failure for the indication statuses si[1] to si[2] to fall in the whitelist ranges w[1] to w[2] is acceptable when user is running, and therefore record “running” as a whitelist activity in the whitelist response.

In a scenario C (FIG. 7c) after the scenario B (FIG. 7b). user again wants to enable a desired function, so the core unit 200 may repeat the flowchart 100 for another round. In the scenario C, it is assumed that user is running. Therefore, when the core unit 200 executes step 104 or 106, the core unit 200 may find that not all the sensed indication statuses si[1] and si[2] fall in the whitelist ranges w[1] and w[2] in step 501 of the flowchart 500, and then proceed to step 503 to consult the sensed activity status SA, which may equal “running” to reflect that user is running. Because the whitelist response already includes a recorded whitelist activity “running” after the scenario B, the current sensed activity status in the scenario C will match the recorded whitelist activity “running” in step 503, and the core unit 200 may proceed to step 504 to accumulate (e.g., increment) a match count associated with the matched whitelist activity “running.” It is assumed that the match count of the whitelist activity “running” has not reached a predetermined threshold in the scenario C. The core unit 200 may proceed to step 502 to determine that the user statuses reflect a consistence with the whitelist response, even though the indication statuses si[1] to si[2] fail to fall in the whitelist ranges w[1] to w[2]. In other words, by recording “running” as the whitelist activity after the scenario B, the core unit 200 may already learn to tolerate the failure for the whitelist ranges w[1] to w[2] to cover the indication statuses si[1] to si[2] when the sensed activity status equal “running” in later scenarios (e.g., the scenario C in FIG. 7c).

In a scenario D (FIG. 7d) after the scenario C (FIG. 7c), user again wants to enable a desired function, so the core unit 200 may repeat the flowchart 100 for another round. In the scenario D, it is assumed that user is running. Therefore, when the core unit 200 executes step 104 or 106, the core unit 200 may find that not all the sensed indication statuses si[1] and si[2] fall in the whitelist ranges w[1] and w[2] in step 501 of the flowchart 500, and then proceed to step 503 to consult the sensed activity status SA, which may equal “running” to reflect that user is running. Because the whitelist response already includes a recorded whitelist activity “running” after the scenario B, the current sensed activity status in the scenario D will match the record whitelist activity “running” in step 503, so the core unit 200 may proceed to step 504 to accumulate (e.g., increment) the match count associated with the matched whitelist activity “running.” It is assumed that the match count of the whitelist activity “running” has reached a predetermined threshold in the scenario D, so the core unit 200 may update one or more of the whitelist ranges w[1] to w[2] in step 504, such that all the indication statuses s[1] to s[2] will be covered respectively by the associated update whitelist ranges w[1] to w[2]. Then the core unit 200 may proceed to step 502 to determine that the user statuses reflect a consistence with the whitelist response. When the match count of the whitelist activity “running” reaches the threshold, the core unit 200 may learn that user frequently requires to enable desired function(s) when running, and therefore update the whitelist range(s) w[1] to w[2] to cover possible values of the indication statuses si[1 ] to si[2] when running. In an embodiment, when updating the whitelist range(s) w[1] to w[2], the core unit 200 may also reset (clear) the match count of the whitelist activity “running”.

In a scenario E (FIG. 7e) after the scenario D (FIG. 7d), user again wants to enable a desired function, so the core unit 200 may repeat the flowchart 100 for another round. In the scenario E, it is assumed that user is running. After updating the whitelist ranges w[1] to w[2] in the scenario D, when the core unit 200 executes step 104 or 106 for the scenario E, the core unit 200 may find that all the sensed indication statuses si[1] and si[2] fall in the updated whitelist ranges w[1] and w[2] in step 501 of the flowchart 500, and then proceed to step 502 to determine that the user statuses reflect a consistence with the whitelist response.

In other words, by step 601 (FIG. 6) and step 504 (FIG. 5), the core unit 200 may learn to properly adapt disagreement between the sensed indication statuses si[1] to si[2] and the whitelist ranges w[1] to w[2] by maintaining whitelist activities according to successful second user-inputted verification(s), and appropriately update the whitelist ranges w[1] to w[2] according to how frequent each whitelist activity occurs.

Please note that the steps shown in FIGS. 1a, 1b, 5 and 6 may be performed in different orders according to different embodiments, and one or more steps may be added or omitted.

To sum up, besides user-inputted verification characteristics, the invention may further leverage other user statuses resulting from additionally sensed accompanying aspects, so as to determine whether user verification is valid to enable desired function(s) of mobile device jointly according to both the user statuses and the user-inputted verification characteristics. Security and reliability of user verification may therefore be improved and enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for improving user verification of a mobile device, comprising:
by a processor of the mobile device, obtaining a user-inputted verification signal which results from one or more user-input modules;
obtaining one or more user statuses which result from one or more sensor modules; and
jointly according to the user-inputted verification signal and the one or more user statuses, determining if the user verification is valid to enable a function of the mobile device.

2. The method of claim 1, wherein determining if the user verification is valid jointly according to the user-inputted verification signal and the one or more user statuses comprises:
if the user-inputted verification signal matches an expected verification signal, and the one or more user statuses reflect a consistence with a whitelist response, then determining that the user verification is valid.

3. The method of claim 1, wherein determining if the user verification is valid jointly according to the user-inputted verification signal and the one or more user statuses comprises:
if the user-inputted verification signal matches an expected verification signal but the one or more statuses reflect an inconsistence with a whitelist response, then determining that the user verification is invalid.

4. The method of claim 1, wherein determining if the user verification is valid jointly according to the user-inputted verification signal and the one or more user statuses comprises:
if the user-inputted verification signal matches an expected verification signal but the one or more user statuses reflect an inconsistence with a whitelist response, prompting user to utilize a second verification approach different from a first verification approach that results in the user-inputted verification signal, and accordingly obtaining a second user-inputted verification signal resulting from the second verification approach; and
if the second user-inputted verification signal matches a second expected verification signal, determining that the user verification is valid.

5. The method of claim 4 further comprising:
if the second user-inputted verification signal matches the second expected verification signal, updating the whitelist response, such that the one or more user statuses reflect a consistence with the updated whitelist response.

6. The method of claim 1, wherein determining if the user verification is valid jointly according to the user-inputted verification signal and the one or more user statuses comprises:
if the one or more user statuses reflect an inconsistence with a whitelist response, but the user-inputted verification signal matches an expected verification signal, determining that the user verification is valid, and updating the whitelist response, such that the one or more user statuses reflect a consistence with the updated whitelist response.

7. The method of claim 1, wherein:
the one or more user statuses include one or more indication statuses; and
determining if the user verification is valid jointly according to the user-inputted verification signal and the one or more user statuses comprises:
if each said indication status falls in an associated whitelist range, determining that the one or more user statuses reflect a consistence with a whitelist response.

8. The method of claim 7, wherein:
the one or more user statuses further include an activity status which reflects sensed user activity by one of a plurality of predetermined activity types; and
determining if the user verification is valid jointly according to the user-inputted verification signal and the one or more user statuses further comprises:
if any said indication status does not fall in said associated whitelist range, checking if the activity status matches any recorded whitelist activity;
if the activity status does not match any recorded whitelist activity, determining that the one or more user statuses reflect an inconsistence with the whitelist response, and prompting user to utilize a second verification approach different from a first verification approach which results in the user-inputted verification signal, and accordingly obtaining a second user-inputted verification signal resulting from the second approach;
if the second user-inputted verification signal matches a second expected verification signal, determining that the user verification is valid, and recording the activity status as a whitelist activity.

9. The method of claim 8, wherein determining if the user verification is valid jointly according to the user-inputted verification signal and the one or more user statuses further comprises:
if any said indication status does not fall in said associated whitelist range but the activity status matches a recorded whitelist activity, determining that the one or more user statuses reflect a consistence with the whitelist response, and accumulating a count associated with the matched recorded whitelist activity; and, if the count associated with the matched recorded whitelist activity reaches a threshold, updating one or more of said one or more whitelist ranges respectively associated with the one or more indication statuses, such that the one or more indication statuses respectively fall in the associated one or more updated whitelist ranges.

10. The method of claim 1, wherein
the one or more user statuses include an activity status and one or more indication statuses;
the activity status reflects sensed user activity by one of a plurality of predetermined activity types;
the plurality of predetermined activity types respectively associates with a plurality of whitelist groups;
each said whitelist group comprises at least one whitelist range, each said whitelist range associates with one of the one or more indication statuses; and
determining if the user verification is valid jointly according to the user-inputted verification signal and the one or more user statuses comprises:
selecting one of said whitelist groups according to the activity status, such that the predetermined activity type associating with the selected whitelist group matches the activity status; and
determining that the one or more user statuses reflect a consistence with a whitelist response if each said whitelist range in the selected whitelist group covers the associated indication status.

11. The method of claim 10, wherein the one or more indication statuses reflect at least one of following user physiology information: blood pressure, heartbeat rate, body temperature, respiration rate, voice stress, perspiration, pupil dilation, pupil size, brainwave and tension.

12. The method of claim 1, wherein the user-inputted verification signal reflects at least one of following: biometric characteristics of user, a sequence of positions inputted by user, a trajectory drawn by user, and a string inputted by user.

13. A processor of a mobile device, comprising:
a core unit; and
an interface circuit bridging between the core unit, one or more user-input modules and one or more sensor modules;
wherein the core unit is arranged to improve user verification by:
obtaining a user-inputted verification signal which results from the one or more user-input modules;
obtaining one or more user statuses which result from the one or more sensor modules; and
jointly according to the user-inputted verification signal and the one or more user statuses, determining if the user verification is valid to enable a function of the mobile device.

14. The processor of claim 13, wherein determining if the user verification is valid jointly according to the user-inputted verification signal and the one or more user statuses comprises:
if the user-inputted verification signal matches an expected verification signal, and the one or more user statuses reflect a consistence with a whitelist response, then determining that the user verification is valid.

15. The processor of claim 13, wherein determining if the user verification is valid jointly according to the user-inputted verification signal and the one or more user statuses comprises:
if the user-inputted verification signal matches an expected verification signal but the one or more user statuses reflect an inconsistence with a whitelist response, then determining that the user verification is invalid.

16. The processor of claim 13, wherein determining if the user verification is valid jointly according to the user-inputted verification signal and the one or more user statuses comprises:
if the user-inputted verification signal matches an expected verification signal but the one or more user statuses reflect an inconsistence with a whitelist response, prompting user to utilize a second verification approach different from a first verification approach that results in the user-inputted verification signal, and accordingly obtaining a second user-inputted verification signal resulting from the second verification approach; and
if the second user-inputted verification signal matches a second expected verification signal, determining that the user verification is valid.

17. The processor of claim 16, wherein the core unit is arranged to improve user verification further by:
if the second user-inputted verification signal matches the second expected verification signal, updating the whitelist response, such that the one or more user statuses reflect a consistence with the updated whitelist response.

18. The processor of claim 13, wherein determining if the user verification is valid jointly according to the user-inputted verification signal and the one or more user statuses comprises:
if the one or more user statuses reflect an inconsistence with a whitelist response, but the user-inputted verification signal matches an expected verification signal, determining that the user verification is valid, and updating the whitelist response, such that the one or more user statuses reflect a consistence with the updated whitelist response.

19. The processor of claim 13, wherein:
the one or more user statuses include one or more indication statuses; and
determining if the user verification is valid jointly according to the user-inputted verification signal and the one or more user statuses further comprises:
if each said indication status falls in an associated whitelist range, determining that the one or more user statuses reflect a consistence with a whitelist response.

20. The processor of claim 19, wherein:
the one or more user statuses further include an activity status which reflects sensed user activity by one of a plurality of predetermined activity types; and
determining if the user verification is valid jointly according to the user-inputted verification signal and the one or more user statuses further comprises:
if any said indication status does not fall in said associated whitelist range, checking if the activity status matches any recorded whitelist activity;
if the activity status does not match any recorded whitelist activity, determining that the one or more user statuses reflect an inconsistence with the whitelist response, and prompting user to utilize a second verification approach different from a first verification approach which results in the user-inputted verification signal, and accordingly obtaining a second user-inputted verification signal resulting from the second approach;
if the second user-inputted verification signal matches a second expected verification signal, determining that the user verification is valid, and recording the activity status as a whitelist activity.
